(19) United States
(12) Patent Application Publication
(10) Pub. No.: US 2004/0048025 A1
(43) Pub. Date: Mar. 11, 2004

(54) Composite tile

(75) Inventor: Steve Lohnes, Georgetown (CA)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: Cappar Limited

(21) Appl. No.: 10/655,379

(22) Filed: Sep. 4, 2003

Related U.S. Application Data
(60) Provisional application No. 60/407,946, filed on Sep. 5, 2002.

(51) Int. Cl. B32B 9/00; B32B 33/00; B32B 27/00; B32B 27/40; B32B 19/00

(52) U.S. Cl. 428/40.1; 428/40.4; 428/688; 428/423.1

(57) ABSTRACT

A composite tile is fabricated to resemble stamped concrete or interlocked brick arrangements. The composite tile may be produced in various shapes, sizes, surface designs and colours and can be applied to outdoor surfaces, for example, asphalt, concrete, or wood surfaces such as driveways, sidewalks, porches, balconies and decks. In one embodiment, a composite tile is provided that comprises a durable, polymer containing mineral layer; an adhesive backing; and a removable protective layer covering the adhesive backing. One method for making the composite tile comprises applying an adhesive backing to a durable, polymer containing mineral layer. A pattern and/or a variegated appearance may be produced either before or after the adhesive is applied by at least one of stamping a pattern onto the polymer containing mineral layer, casting/molding the polymer containing mineral layer in a mold such as a tray, varying the mineral appearance of the polymer containing mineral layer, and varying the pigmentation therein. The composite tile may, if necessary, be cut to an appropriate size/shape.

### CROSS REFERENCE TO RELATED APPLICATIONS

This application claims priority from U.S. Provisional Patent Application Serial No. 60/407,946, which was filed on Sep. 5, 2002.

### FIELD OF THE INVENTION

The present invention relates to a composite tile, in particular, it relates to a composite tile that is applicable to outdoor surfaces such that it may resemble stamped concrete or interlocking brick arrangements.

### BACKGROUND OF THE INVENTION

A variety of floor tiles are available for indoor uses. Representative examples of such tiles include ceramic and other glazed tiles, parquet tiles, wooden tiles, vinyl tiles, linoleum tiles, cork tiles, and quarry tiles. Due to their low resistance to breakage and/or poor weathering characteristics, such tiles are not suitable or practical for outdoor installation and use.

Stamped concrete and interlocked brick arrangements are widely used for replacing asphalt driveways and sidewalks. However, both stamped concrete and interlocking brick are costly and difficult to install. In the case of interlocking brick, a great deal of maintenance is required to upkeep its appearance.

U.S. Pat. Nos. 3,991,529 and 4,079,554 describe synthetic facing materials that create the appearance of brick, stone, or the like. Typically, vinyl sheets are provided with a series of simulated brick face sections, which are separable by ordinary flexing. These sheets are provided with a self-adhesive allowing the simulated sections to be readily adhered onto a suitable surface. Such vinyl decorative sheets, while easy to install, are not suitable for outdoor exterior surfaces accommodating different types of traffic wear and tear.

In view of the foregoing, there is a need for a tile suitable for outdoor use on a variety of surfaces, for example, asphalt, concrete or wood surfaces, such as driveways or walkways, that is durable, cost-effective and easily installed by non-professional “do-it-yourselfers.” Furthermore such tile resembles the traditional, more expensive stamped concrete and interlocking brick arrangements.

### SUMMARY OF THE INVENTION

The present invention is directed to a composite tile that resembles stamped concrete or interlocking brick arrangements. The composite tile is durable and wear resistant and thus, is suitable for outdoor environmental conditions and can accommodate traffic wear and tear. The composite tile of the invention comprises a durable, polymer containing mineral layer and an adhesive backing capable of adhering to an outdoor surface.

In another aspect of the present invention, there is provided a composite tile comprising a durable, polymer containing mineral layer; an adhesive backing capable of adhering to an outdoor surface; and a removable protective layer covering the adhesive backing.

In yet another aspect of the present invention, there is provided a composite tile comprising a durable, polymer containing mineral layer; an adhesive backing capable of adhering to an outdoor surface; and a removable protective layer covering the adhesive backing, wherein said polymer containing mineral layer has a surface resembling stamped concrete or interlocking brick arrangements.

In another aspect of the present invention, there is provided a method for making a composite tile, the method comprising applying an adhesive backing, capable of adhering to an outdoor surface, to a durable, polymer containing mineral layer or applying the durable, polymer containing mineral layer to the adhesive backing.

In another aspect of the present invention, there is provided a method for making a composite tile, the method comprising applying an adhesive backing, capable of adhering to an outdoor surface, to a durable, polymer containing mineral layer or applying the durable, polymer containing mineral layer to the adhesive backing; and optionally applying a removable protective layer to the adhesive backing.

In another aspect of the present invention, there is provided a method for making a composite tile, the method comprising applying an adhesive backing, capable of adhering to an outdoor surface, to a durable, polymer containing mineral layer or applying the durable, polymer containing mineral layer to the adhesive backing, wherein at least one of before and after the adhesive is applied, the method further comprises at least one of stamping a pattern onto the polymer containing mineral layer, casting/molding the polymer containing mineral layer, varying a mineral appearance of the polymer containing mineral layer, and varying pigmentation therein. In addition, optionally applying a removable protective layer to the adhesive backing.

In yet another aspect of the present invention, there is provided a kit for applying composite tiles, the kit comprising a plurality of composite tiles, each comprising a durable, polymer containing mineral layer, an adhesive backing capable of adhering to an outdoor surface, and a removable protective layer covering the adhesive backing. The kit may be provided in a suitable packaging and contain instructions for use.

### DETAILED DESCRIPTION OF THE PREFERRED EMBODIMENTS

The present invention is a composite tile that may be applied to a variety of outdoor surfaces, for example, asphalt or concrete surfaces such as driveways, sidewalks, porches, balconies and decks so that the surface may resemble stamped concrete or interlocking brick arrangements. The composite tile is durable and wear resistant and thus, is suitable for a variety of weather-related conditions and can accommodate traffic wear and tear. The tile is easy to use and install as a durable “peel-and-stick” tile that is readily installed by any “do-it-yourselfer.”

Although the composite tile of the present invention was formulated for outdoor use, the composite tile may also be applicable for indoor applications such as, for instance, garage or basement floors.

The composite tile of the present invention may be produced in various shapes, sizes, surface designs and colours. Typically, the tile has an outward appearance of natural materials such as stone, slate, brick or cobble.

The composite tile of the present invention comprises a bottom adhesive backing for adhering to a selected surface, such as asphalt, concrete or wood, and a top durable, polymer containing mineral layer.

The top durable, polymer containing mineral layer is selected from the group consisting of a polymer modified concrete (PMC) layer; a polymer concrete (PC) layer; a slim masonry veneer layer; and mixtures thereof. The polymer modified concrete (PMC) layer refers to a mixture of at least one polymer, portland cement and at least one aggregate. The polymers used in PMC are typically acrylics, epoxy resins, polyurethanes, styrene-butadiene resins and mixtures thereof. The polymer concrete (PC) layer refers to a mixture of at least one polymer and at least one aggregate. The polymers used in PC are typically polyesters, polyvinyl esters, epoxy resins, polyurethanes, polymethylmethacrylates and mixtures thereof. In a preferred embodiment, the polymer concrete (PC) layer is formed from at least one thermosetting polymer and at least one aggregate.

Accordingly, in a preferred embodiment of the present invention, the durable, polymer containing mineral layer comprises an aggregate content of at least 91% by weight and at most 9% by weight of a thermosetting polymer. Typically, the polymer concrete layer contains about 92-96% by weight of the aggregate, and correspondingly about 4-8% by weight of the polymer.

Various thermosetting polymers may be used in the durable, polymer containing mineral layer. Preferred examples of the thermosetting polymers are thermosetting polymers that have been formed from the reaction of epoxy resins (such as those based on at least one of Bisphenol-A and Bisphenol-F) and at least one of an aliphatic and a cycloaliphatic amine. Epoxy resins based on Bisphenol-A are typically a reaction product of bisphenol-A and epichlorohydrin, which gives the diglycidyl ether of bisphenol-A. The equivalent weight is preferably about 182-192, and such a resin has a viscosity at 25° C. of 11000-14000 mPa-sec. Epoxy resins based on Bisphenol-F are typically a reaction product of bisphenol-F and epichlorohydrin. The equivalent weight is preferably about 160, and such a resin has a viscosity at 25° C. of about 3500 mPa-sec. Examples of aliphatic amines are triethylene tetramine and diethylene triamine. Examples of cycloaliphatic amines are isophorone diamine, N-amino ethyl piperazine and diaminocyclohexane.

The aggregate may be any mineral particulate filler such as particulate siliceous fillers (e.g. sand, gravel, quartz stones and the like) and non-siliceous fillers. Preferably, the mineral particulate filler has generally rounded edges. This provides a lesser surface area for polymer “wetting,” lesser void formation, and such profiles are generally higher in impact/compression load resistance. Typically, the mineral particulate filler is comprised of at least 40% by weight, preferably at least 50% by weight, of a particle size that is greater than 0.4 mm; at least 70% by weight, preferably at least 80% by weight, of a particle size that is greater than 0.2 mm; and at least 85% by weight, preferably about 100% by weight, of a particle size that is greater than 0.1 mm, preferably greater than 0.04 mm.

In most instances, the aggregate further comprises at least one coupling/wetting agent. Examples of such coupling/wetting agents are selected from the group consisting of saturated polyesters with acid groups, titanate coupling agents, functional silanes, and mixtures thereof. The coupling/wetting agent may be present in a range of about 0.1-0.5% by weight (based on the total weight of aggregate). Typically, the coupling/wetting agent is about 0.25% by weight.

In various embodiments, at least one pigment may be added to the durable, polymer containing mineral layer to vary the pigmentation. Some of the examples of pigments that may be used are red iron oxide, black iron oxide and titanium oxide. In addition, the aggregate itself may contain coloured quartz to vary the colour of the tile.

The polymer containing mineral layer may be manufactured to have a thickness that varies over a wide range. An average thickness may be in the range of about 1-10 mm, more preferably about 2-10 mm, and most preferably, the average thickness would be about 5-6 mm.

With respect to the adhesive backing, this layer comprises an adhesive that adheres well to surfaces, preferably outdoor surfaces such as asphalt or concrete. The adhesive backing may be a thermoset urethane polymer, bitumen or asphalt composition, a polymer-modified bitumen or polymer-modified asphalt composition. In preferred embodiments, the adhesive is a butadiene modified asphalt emulsion.

The adhesive backing may be a continuous or a non-continuous layer of adhesive. Preferably, the adhesive backing is continuous when used on suspended decks, ramps, porches, balconies and the like, and non-continuous when used on driveways, walkways or the like. Some examples of adhesives that are suitable as continuous layers of adhesive are bitumen or asphalt emulsions, or polymer-modified bitumen or asphalt emulsions, with a reinforcing material to produce a continuous membrane material. The reinforcing material may be fibreglass or any other synthetic or natural reinforcing material. In some embodiments, the adhesive backing used in the composite tile of the present invention is a roofing membrane such as that manufactured by IKO SALES INTERNATIONAL, Industriezone Ravenshout 3185 3945 Ham, Belgium or BAKOR, INC., 284 Watline Avenue, Mississauga, Ontario L4Z 1P4 Canada.

In embodiments where the adhesive backing is non-continuous, the adhesive layer only partially covers one side of the polymer containing mineral layer. Typically, about 20-40% of the side of the polymer containing mineral layer is covered with adhesive. Such a non-continuous arrangement of adhesive provides better venting and release of moisture through the bonded tile. The non-continuous adhesive preferably comprises a thermoset urethane polymer and, most preferably, a butadiene modified asphalt emulsion.

To obtain a non-continuous adhesive layer, the adhesive may be applied to the polymer containing mineral layer using a template, stencil or curtain coating. Preferably, the non-continuous adhesive layer created is a series of discrete areas such as strips or circles of adhesive, which are spaced apart to cover about 20-40% of one side of the tile area. In some embodiments, for a tile having dimensions of 900 mm×450 mm, circles of adhesive are applied having a diameter of 19 mm and the thickness of the adhesive is about 1.5 mm.

The adhesive backing may also have a peel and stick arrangement, whereby the adhesive backing has a removable protective covering, such as treated paper or plastic, that can be peeled away to reveal the adhesive backing. Hence, the tile can be applied by removing the protective covering from the adhesive backing and affixing it to a surface area. This makes for easy installation of the tiles by non-professional “do-it-yourselfers.”

The adhesive backing may also have a thickness that varies over a wide range. Typically, the thickness would be in the range of about 0.5-3 mm, and more preferably, the thickness would be about 1-2 mm. The overall thickness of the composite tile is preferably about 2-10 mm and thus, it retains a degree of flexibility. This property of flexibility aids in durability, as well as allows the tile to be installed on uneven surfaces.

There are various techniques known by those skilled in the art that may be utilised to make the composite tile of the present invention. The durable, polymer containing mineral layer may be applied to the adhesive backing (or the adhesive backing may be applied to the durable, polymer containing mineral layer). A pattern and/or a variegated appearance may be produced either before or after the adhesive is applied by at least one of stamping a pattern onto the polymer containing mineral layer, casting/molding the polymer containing mineral layer in a mold such as a tray, varying the mineral appearance of the polymer containing mineral layer, and varying the pigmentation therein. The tile is cured, either before or after application of adhesive, and, if necessary, cut to an appropriate size such as 900 mm×450 mm.

Preferred methods include producing a pattern and/or a variegated appearance onto a durable, polymer containing mineral layer by at least one of stamping a pattern onto the durable, polymer containing mineral layer, casting/molding the polymer containing mineral layer, varying the mineral appearance of the polymer containing mineral layer, and varying the pigmentation therein. An adhesive backing is applied to the polymer containing mineral layer before and/or after the tile is cured. The adhesive backing may be applied as a non-continuous layer as described previously.

A preferred method of the present invention includes casting the durable, polymer containing mineral layer in a mold, such as a tray. The mold may be any shape, but is typically rectangular. A pattern may be imparted to the polymer containing mineral layer as follows: the mold may have, at its bottom, a pattern which is imparted to the polymer containing mineral layer as the polymer containing mineral layer is compressed into the mold; or a pattern may be directly stamped onto the polymer containing mineral layer. The pattern may resemble stone, slate, cobble or brick. An adhesive backing is applied to the polymer containing mineral layer either before or after the tile is cured. The adhesive backing may be applied as a non-continuous layer as described previously. The tile is cured and, when removed from the mold, is typically 900 mm×450 mm.

In addition, other steps may include: a) applying a removable layer to the adhesive backing; b) if the adhesive backing is continuous, applying a thin layer of thermosetting polymer to the adhesive backing prior to application of the durable, polymer containing mineral layer or applying a thin layer of thermosetting polymer to the durable, polymer containing mineral layer prior to application of the adhesive backing; and/or c) sealing the tile using a polymer sealer to coat and strengthen the tile prior to curing.

To easily supply a certain amount of tiles for completing a surface area, it would be beneficial to provide a consumer with a kit. For instance, the kit may comprise a plurality of composite tiles, each comprising a polymer containing mineral layer, an adhesive backing capable of adhering to an outdoor surface, and a removable protective layer covering the adhesive backing. The kit may also include a suitable packaging and a set of instructions to facilitate installation.

### EXAMPLES

The following examples are being submitted to further illustrate various embodiments of the present invention. These examples are intended to be illustrative only and are not intended to limit the scope of the present invention.

### Example I

A composite tile was made by placing and fully compressing about 5.0 to 5.5 kg, sufficient to yield an average thickness of about 5-6 mm, of polymer concrete into a metal tray, which is 900 mm×450 mm×6 mm deep. The polymer concrete layer contains a mixture of about 6% by weight of a thermosetting polymer, which is polyurethane modified Bisphenol A epoxy cured with cyclo-aliphatic amine, and about 94% by weight of graded silica aggregates with dry pigments. The aggregate contains a mixture of coupling/wetting agents and mineral particulate filler having generally rounded edges. The mineral particulate filler is comprised of 50% by weight of a particle size that is greater than 0.4 mm, 80% by weight of a particle size that is greater than 0.2 mm and 100% by weight of a particle size that is greater than 0.04 mm. About 0.25% by weight of titanate coupling/wetting agents (based on the total weight of aggregate) are used.

Coloured quartz may be added to the polymer concrete layer if further colour highlights are preferred. A preferred pattern is stamped into the polymer concrete layer. The overall pattern dimension is 900 mm×450 mm.

A sealer, comprised of a water-based urethane modified acrylic, is applied to the surface of the tile to consolidate the colour and further strengthen the tile.

The tile is then cured in an oven at 65° C. for 2 hours. Upon cooling, the tile is removed from the tray. To assist in applying adhesive in a non-continuous manner to the tile, a template is placed on one side of the tile. The adhesive, a butadiene modified asphalt emulsion, which cures to a tacky adhesive, is applied to the template side of the tile to yield a thickness of adhesive that is about 1.0 mm. The template is then removed and a removable layer is then placed over the adhesive to isolate it from other tiles and permit the tiles to be packaged in a kit.

### Example II

A thin skin pattern resembling stone, slate, cobble, or brick is bonded to the bottom of a metal tray, or a pattern resembling stone, slate, cobble, or brick is pressed directly into the bottom of the metal tray. A composite tile was made by placing and fully compressing about 5.0 to 5.5 kg, sufficient to yield an average thickness of about 5-6 mm, of polymer concrete into the metal tray, which is 900 mm×450 mm ×6 mm deep. The polymer concrete layer contains a mixture similar to Example I.

Coloured quartz may be added to the polymer concrete layer if further colour highlights are preferred.

The adhesive, a butadiene modified asphalt emulsion, is applied to the polymer concrete layer in strips and the tray and its' contents are then cured at 60-70° C. for 2 hours.

The tile is demolded and a treated paper is applied over the adhesive backing to isolate the tile adhesive for packaging and to provide a peel and stick function for installation.

A sealer, comprised of a water-based urethane modified acrylic, is applied to the surface of the tile to consolidate the colour and further strengthen the tile.

### Example III

A composite tile was made by placing an adhesive backing comprising a roofing membrane (manufactured by either IKO SALES INTERNATIONAL, Industriezone Ravenshout 3185 3945 Ham, Belgium or BAKOR, INC., 284 Watline Avenue, Mississauga, Ontario L4Z 1P4 Canada) onto a horizontal surface. A removable layer of plastic is then placed on one side of the adhesive backing.

A thermosetting polymer is applied as a primer onto the other side of the adhesive backing, at about 5 m ²/Litre. The thermosetting polymer has an equivalent weight of about 182-192 and results from a reaction of a diglycidyl ether of bisphenol-A with triethylene tetramine. While the thermosetting polymer is still wet (within 30 minutes), a polymer concrete layer is applied to the primer and compacted to a thickness of about 5-7 mm. The polymer concrete layer contains a mixture of about 5% by weight of the thermosetting polymer and about 95% by weight of graded silica aggregates with dry pigments. The aggregate contains a mixture of coupling/wetting agents and mineral particulate filler having generally rounded edges. The mineral particulate filler is comprised of 50% by weight of a particle size that is greater than 0.4 mm, 80% by weight of a particle size that is greater than 0.2 mm and 100% by weight of a particle size that is greater than 0.04 mm. About 0.25% by weight of titanate coupling/wetting agents (based on the total weight of aggregate) are used.

A preferred pattern is stamped into the polymer concrete layer. The overall pattern dimension is about 900 mm×450 mm. At this stage, further dry pigment and/or coloured quartz may be added to the polymer concrete layer if further colour highlights are preferred.

A coating of the thermosetting polymer is applied at about 5 m²/Litre to the polymer concrete layer to provide a sealer layer. The total thickness of the tile is approximately 6-9 mm.

The composite tile is allowed to set for about 2 to 4 hours at ambient temperature (or for about 1 hour at about 60° C.). The tile can then be cut to an appropriate size.

Although preferred embodiments of the invention have been described herein in detail, it will be understood by those skilled in the art that variations may be made thereto without departing from the spirit of the invention.

1. A composite tile comprising:
a durable, polymer containing mineral layer; and
an adhesive backing capable of adhering to an outdoor surface.

2. The composite tile of claim 1, wherein the durable, polymer containing mineral layer is selected from the group consisting of a polymer modified concrete (PMC) layer, a polymer concrete (PC) layer, a slim masonry veneer layer, and mixtures thereof.

3. The composite tile of claim 2, wherein the durable, polymer containing mineral layer is the polymer concrete (PC) layer.

4. The composite tile of claim 2, wherein the durable, polymer containing mineral layer is the polymer modified concrete (PMC) layer.

5. The composite tile of claim 3, wherein the polymer concrete (PC) layer is formed from a mixture of at least one polymer and at least one aggregate.

6. The composite tile of claim 4, wherein the polymer modified concrete (PMC) layer is formed from a mixture of at least one polymer, portland cement and at least one aggregate.

7. The composite tile of claim 5, wherein said at least one polymer is selected from the group consisting of polyesters, polyvinyl esters, epoxy resins, polyurethanes, polymethylmethacrylates and mixtures thereof.

8. The composite tile of claim 6, wherein said at least one polymer is selected from the group consisting of acrylics, epoxy resins, polyurethanes, styrene-butadiene resins and mixtures thereof.

9. The composite tile of claim 2, wherein the durable, polymer containing mineral layer comprises an aggregate content of at least 91% by weight and a thermosetting polymer content of, at most, 9% by weight.

10. The composite tile of claim 9 wherein the aggregate content is about 92-96% by weight and the thermosetting polymer is about 4-8% by weight.

11. The composite tile of claim 9, wherein said at least one aggregate is a particulate siliceous filler.

12. The composite tile of claim 5 wherein said at least one aggregate is a mineral particulate filler with generally rounded edges.

13. The composite tile of claim 9 wherein the aggregate is a mineral particulate filler with generally rounded edges.

14. The composite tile of claim 13 wherein the mineral particulate filler is comprised of at least 40% by weight of a particle size that is greater than 0.4 mm, at least 70% by weight of a particle size that is greater than 0.2 mm and at least 85% by weight of a particle size that is greater than 0.1 mm.

15. The composite tile of claim 14 wherein the mineral particulate filler is comprised of at least 50% by weight of a particle size that is greater than 0.4 mm, at least 80% by weight of a particle size that is greater than 0.2 mm and about 100% by weight of a particle size that is greater than 0.1 mm.

16. The composite tile of claim 9 wherein the thermosetting polymer is obtained by reaction of (a) an epoxy resin, formed from at least one of Bisphenol A and Bisphenol F, with (b) an amine selected from the group consisting of an aliphatic amine and a cyclo-aliphatic amine.

17. The composite tile of claim 16 wherein the epoxy resin is a Bisphenol-A resin with an equivalent weight of about 182-192 or a Bisphenol-F resin with an equivalent weight of about 160.

18. The composite tile of claim 16 wherein the amine is selected from the group consisting of triethylene tetramine, diethylene triamine, isophorone diamine, N-amino ethyl piperazine and diaminocyclohexane, and mixtures thereof.

19. The composite tile of claim 1 wherein the durable, polymer containing mineral layer has at least one coupling/wetting agent.

20. The composite tile of claim 19 wherein said at least one coupling/wetting agent is selected from the group consisting of saturated polyesters with acid groups, titanate coupling agents and functional silanes, and mixtures thereof.

21. The composite tile of claim 1 wherein the durable, polymer containing mineral layer has a pigment.

22. The composite tile of claim 1 wherein the durable, polymer containing mineral layer has a thickness in the range of about 2-10 mm.

23. The composite tile of claim 1 wherein the outdoor surface is selected from the group consisting of concrete, asphalt and wood.

24. The composite tile of claim 1 wherein the adhesive backing is a continuous layer of adhesive.

25. The composite tile of claim 1 wherein the adhesive backing is a non-continuous layer of adhesive.

26. The composite tile of claim 25 wherein the layer of adhesive covers about 20% to 40% of one side of the durable, polymer containing mineral layer.

27. The composite tile of claim 24 wherein the adhesive backing is a continuous membrane material comprising a reinforcing material and an emulsion selected from the group consisting of a bitumen emulsion, an asphalt emulsion, a polymer-modified bitumen emulsion and a polymer-modified asphalt emulsion.

28. The composite tile of claim 27 wherein the reinforcing material is a synthetic or natural reinforcing material.

29. The composite tile of claim 24 wherein the adhesive is a roofing membrane.

30. The composite tile of claim 25 wherein the adhesive is a thermoset urethane polymer.

31. The composite tile of claim 25 wherein the adhesive is a butadiene modified asphalt emulsion.

32. The composite tile of claim 1 further comprising a removable protective layer covering the adhesive backing.

33. The composite tile of claim 32 wherein the removable protective layer is treated paper or treated plastic.

34. The composite tile of claim 1 wherein the adhesive backing has a thickness of about 0.5-3 mm.

35. The composite tile of claim 1 is flexible and has a thickness of about 2-10 mm.

36. The composite tile of claim 1 wherein the durable, polymer containing mineral layer has a pattern.

37. The composite tile of claim 36 wherein the pattern resembles one of stone, slate, brick and cobble.

38. The composite tile of claim 1 wherein the durable, polymer containing mineral layer has a variegated aggregate appearance.

39. A kit for applying composite tiles to surfaces, the kit comprising a plurality of tiles including at least one tile having
a durable, polymer containing mineral layer;
an adhesive backing capable of adhering to an outdoor surface; and
a removable protective layer covering the adhesive backing.

40. A method for making a composite tile, the method comprising applying an adhesive backing, capable of adhering to an outdoor surface, to a durable, polymer containing mineral layer or applying the durable, polymer containing mineral layer to the adhesive backing.

41. The method of claim 40, wherein the durable, polymer containing mineral layer is selected from the group consisting of a polymer modified concrete (PMC) layer, a polymer concrete (PC) layer, a slim masonry veneer layer and mixtures thereof.

42. The method of claim 40, wherein at least one of before and after the adhesive is applied, the method further comprises at least one of stamping a pattern onto the polymer containing mineral layer, casting/molding the polymer containing mineral layer, varying a mineral appearance of the polymer containing mineral layer, and varying pigmentation therein.

43. The method of claim 42, further comprising curing the tile at least one of before and after the adhesive is applied.

44. The method of claim 43, further comprising cutting the durable, polymer containing mineral layer to an appropriate size/shape.

45. The method of claim 40, further comprising casting the durable, polymer containing mineral layer into a mold; and applying the adhesive backing to the durable, polymer containing mineral layer at least one of before and after the adhesive is applied.

46. The method of claim 45, wherein the mold comprises a pattern which is imparted to the durable, polymer containing mineral layer as the polymer containing mineral layer is compressed into the mold.

47. The method of claim 45, wherein a pattern is stamped onto the durable, polymer containing mineral layer prior to application of the adhesive backing.

48. The method of claim 46, wherein the pattern resembles one of stone, slate, brick and cobble.

49. The method of claim 40, wherein the adhesive backing is applied as a continuous or non-continuous layer of adhesive.

50. The method of claim 49, wherein the layer of adhesive is applied to the durable, polymer containing mineral layer using one of a template, stencil and curtain coating.

51. The method of claim 49, wherein the layer of adhesive is applied as discrete areas.

52. The method of claim 51, wherein the discrete areas are at least one of circles and strips.

53. The method of claim 51, wherein the discrete areas cover about 20% to 40% of one side of the durable, polymer containing mineral layer.

54. The method of claim 40, further comprising applying a removable protective layer covering to the adhesive backing.

55. The method of claim 40, further comprising applying a thermosetting polymer layer to the adhesive backing, prior to application of the durable, polymer containing mineral layer or applying a thin layer of thermosetting polymer to the durable, polymer containing mineral layer prior to application of the adhesive backing.

56. The method of claim 40, further comprising sealing the tile with a polymer sealer.
